(19) United States
(12) Patent Application Publication
(10) Pub. No.: US 2013/0076968 A1
(43) Pub. Date: Mar. 28, 2013

(54) IMAGE SENSING DEVICE

(71) Applicants: Masaaki Ueda, Katano City (JP); Kanichi Koyama, Higashiosaka City (JP)

(72) Inventors: Masaaki Ueda, Katano City (JP); Kanichi Koyama, Higashiosaka City (JP)

(73) Assignee: SANYO ELECTRIC CO., LTD., Moriguchi City (JP)

(21) Appl. No.: 13/597,542

(22) Filed: Aug. 29, 2012

(30) Foreign Application Priority Data
Sep. 27, 2011 (JP) 2011-210282

(51) Int. Cl. H04N 5/232

(52) U.S. Cl. 348/345; 348/E05.042

(57) ABSTRACT

An image sensing device includes: an image sensor that generates an image signal of a subject image; a reading control portion that reads the image signal in a selected reading mode; a focus control portion that performs focus processing which detects, based on the read image signal, a relative position relationship between a focus lens and the image sensor for focusing the subject image; and a reading mode selection portion that selects, based on the read image signal, a reading mode for performing the focus processing.

### CROSS-REFERENCE TO RELATED APPLICATIONS

This nonprovisional application claims priority under 35 U.S.C. §119(a) on Patent Application No. 2011-210282 filed in Japan on Sep. 27, 2011, the entire contents of which are hereby incorporated by reference.

### BACKGROUND OF THE INVENTION

1. Field of the Invention

The present invention relates to image sensing devices such as a digital camera.

2. Description of Related Art

AF control (autofocus control) using a contrast detection method has been put to practical use. In the AF control using the contrast detection method, the movement of a focus lens causes the contrast of a subject image on an image sensor to be changed, and thus the position of the focus lens (focusing lens position) in which the contrast (edge intensity) is maximized is found.

Since the intensity of the edge is determined by the relative comparison of frames, in order to accurately achieve focus (that is, in order to accurately find the focusing lens position), it is necessary to use evaluation values (edge evaluation values) for a large number of frames. However, as the number of frames is increased, a focusing time (a time required for the AF control) is increased. Hence, when the AF control is performed, the drive mode of the image sensor is switched to a drive mode having a large frame rate, and thus the number of evaluation values obtained within a predetermined time is increased, with the result that the focusing time is reduced.

Since the amount of data that can be read, per unit time, from the image sensor such as a CMOS (complementary metal oxide semiconductor) image sensor is limited, in order to achieve a high frame rate, it is necessary to generally thin out target pixels to be read. In general, as shown in FIG. 19, when signals are read, several pixels are omitted by thinning-out along a vertical direction. In FIG. 19, diagonally shaded portions represent target portions to be omitted by thinning-out (the same is true for FIG. 20, which will be described later). Naturally, signals for the portions omitted by thinning-out are not utilized for the AF control.

There is a conventional technology that utilizes thinning-out reading to perform AF control.

As described above, the thinning-out reading is utilized, and thus it is possible to achieve a high frame rate and high-speed AF. However, since the amount of information on signals utilized for AF control is reduced by the thinning-out reading, thinning-out itself is undesirable for achieving highly accurate AF. In particular, for example, as shown in FIG. 20, when a subject image having highly intense edge components in a horizontal direction is thinned out in the vertical direction or when the amount of thinning-out in the vertical direction is excessively increased, edge components important for contrast variation detection (in the example of FIG. 20, the edge components of eyebrows and a mouth) do not become the evaluation target of AF control, and thus the AF accuracy is significantly degraded. As described above, there is a tradeoff between the AF accuracy and the frame rate at the time of AF (in other words, the AF speed). It is beneficial that necessary AF accuracy can be acquired and that furthermore, the frame rate at the time of AF can be increased.

### SUMMARY OF THE INVENTION

According to the present invention, there is provided an image sensing device including: an image sensor that generates an image signal of a subject image which enters the image sensor through a focus lens; a reading control portion that reads the image signal in a reading mode which is selected from a plurality of reading modes for reading the image signal from the image sensor; a focus control portion that performs focus processing which detects, based on the image signal read by the reading control portion, a relative position relationship between the focus lens and the image sensor for focusing the subject image; and a reading mode selection portion that selects, based on the image signal read from the image sensor, a reading mode for performing the focus processing.

### BRIEF DESCRIPTION OF THE DRAWINGS

FIG. 1 is a schematic overall block diagram of an image sensing device according to an embodiment of the present invention;

FIG. 2 is a diagram showing the internal configuration of an image sensing portion of FIG. 1;

FIG. 3 is a diagram for illustrating the significance of reading;

FIG. 4 is a diagram showing how a plurality of light-receiving pixels are arranged on an image sensor;

FIGS. 5A to 5C are diagrams showing how all-pixel reading, thinning-out reading and addition reading are performed;

FIGS. 6A and 6B are diagrams for illustrating a horizontal thinning-out amount and a vertical thinning-out amount in the thinning-out reading;

FIGS. 7A and 7B are diagrams for illustrating a horizontal addition amount and a vertical addition amount in the addition reading;

FIG. 8 is a diagram showing a color filter arrangement in the image sensor and R, B, Gr and Gb surfaces formed based on the color filters;

FIG. 9 is an operational flow chart of an image sensing device according to a first example of the present invention;

FIG. 10 is a diagram showing an edge evaluation image according to the first example of the present invention;

FIG. 11 is an internal block diagram of an edge evaluation portion according to the first example of the present invention;

FIGS. 12A to 12D are diagrams for illustrating the significance of a horizontal edge and a vertical edge;

FIGS. 13A and 13B are diagrams showing an example of horizontal and vertical edge extraction filters in the first example of the present invention;

FIGS. 14A and 14B are diagrams for illustrating two thinning-out reading modes according to the first example of the present invention;

FIG. 15 is a diagram showing n sheets of AF input images acquired in AF processing;

FIG. 16 is a diagram showing a relationship between horizontal and vertical edge intensity evaluation values and the selected thinning-out reading mode in a second example of the present invention;

FIG. 17 is an operational flow chart of an image sensing device according to a third example of the present invention;

FIG. 18 is a diagram showing a relationship between horizontal and vertical edge intensity evaluation values and the selected addition reading mode in a fourth example of the present invention;

FIG. 19 is a diagram for illustrating a conventional thinning-out reading method; and

FIG. 20 is a diagram for illustrating the conventional thinning-out reading method.

### DETAILED DESCRIPTION OF PREFERRED EMBODIMENTS

Examples of the embodiment of the present invention will be specifically described below with reference to accompanying drawings. In the referenced drawings, like parts are identified with like symbols, and the description of the like parts will not be repeated in principle. In the present specification, for ease of description, a sign or a symbol representing information, a physical amount, a state amount, a member or the like is shown, and thus the name of the information, the physical amount, the state amount, the member or the like corresponding to the sign or the symbol may be omitted or described for short.

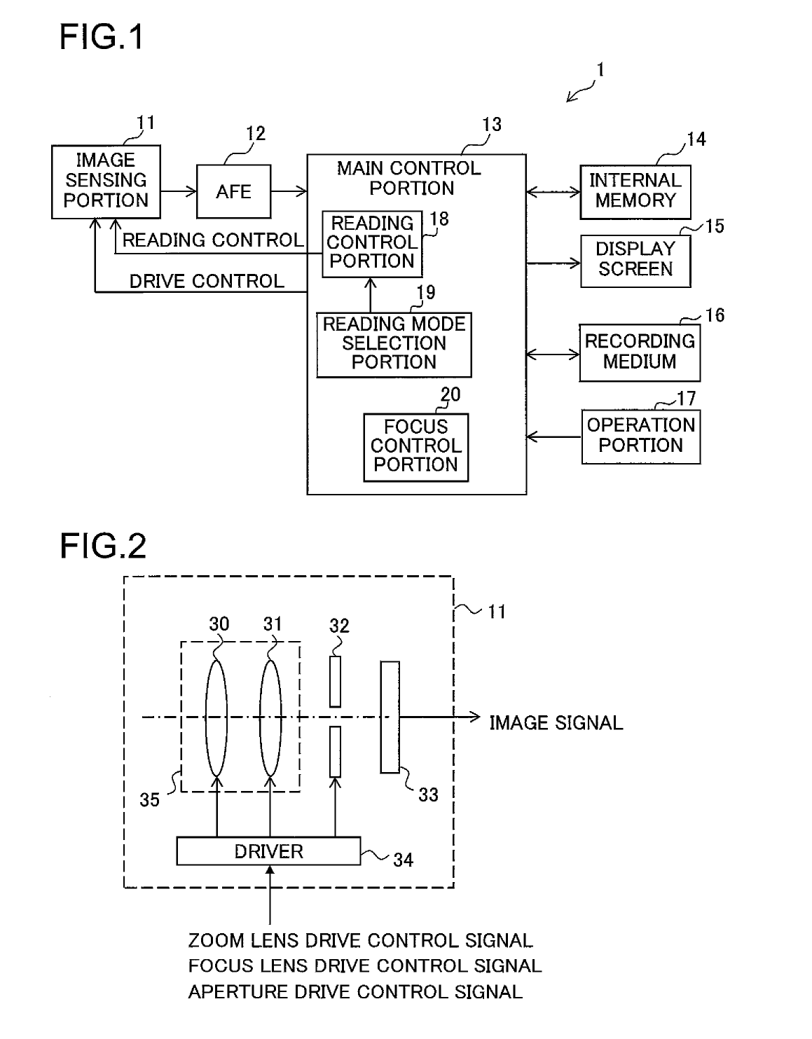

FIG. 1 is a schematic overall block diagram of an image sensing device 1 according to the embodiment of the present invention. The image sensing device 1 is a digital video camera that can shoot and record a still image and a moving image. The image sensing device 1 may be a digital still camera that can shoot and record only a still image.

The image sensing device 1 includes an image sensing portion 11, an AFE (analog front end) 12, a main control portion 13, an internal memory 14, a display screen (display portion) 15, a recording medium 16 and an operation portion 17. In the main control portion 13, a reading control portion 18, a reading mode selection portion 19 and a focus control portion 20 are provided.

FIG. 2 is a diagram showing the internal configuration of the image sensing portion 11. The image sensing portion 11 includes: an optical system 35 that is formed with a plurality of lenses including a zoom lens 30 and a focus lens 31; an aperture 32; an image sensor (solid-state image sensor) 33 that is formed with a CMOS (complementary metal oxide semiconductor) image sensor; and a driver 34 for driving and controlling the optical system 35 and the aperture 32. The image sensor 33 may be formed with a CCD (charge coupled device). The image sensor 33 photoelectrically converts an optical image of a subject within a shooting region that enters the image sensor 33 through the optical system 35 and the aperture 32, and outputs an image signal that is an electrical signal obtained by the photoelectrical conversion. The shooting region refers to the shooting region (view) of the image sensing device 1. The AFE 12 digitizes and amplifies the output signal of the image sensor 33 that is the output signal of the image sensing portion 11, and outputs the digitized and amplified output signal of the image sensor 33.

The driver 34 has the function of a lens drive portion, and moves the zoom lens 30 to a position corresponding to a zoom lens drive control signal from the main control portion 13 and moves the focus lens 31 to a position corresponding to a focus lens drive control signal from the main control portion 13. In the focus control portion 20, the focus lens drive control signal can be generated. Furthermore, the driver 34 adjusts the opening of the aperture 32 according to an aperture drive control signal from the main control portion 13. In the following description, the position of the focus lens 31 within the optical system 35 is also referred to as a focus lens position.

The main control portion 13 performs necessary signal processing on the output signal of the AFE 12. Moreover, the main control portion 13 comprehensively controls the operation of individual portions within the image sensing device 1. The internal memory 14 is formed with a SDRAM (synchronous dynamic random access memory) or the like, and temporarily stores various types of signals (data) generated within the image sensing device 1. The display screen 15 is formed with a liquid crystal display panel or the like, and displays, under control by the main control portion 13, a shooting image, an image recorded in the recording medium 16 or the like. The recording medium 16 is a nonvolatile memory such as a card-shaped semiconductor memory or a magnetic disc, and records a shooting image or the like under control by the main control portion 13.

The operation portion 17 includes a plurality of buttons, and receives various types of operations from a user. The operation portion 17 may be formed with a touch panel. The details of the operation performed by the user on the operation portion 17 are transmitted to the main control portion 13; under control by the main control portion 13, each portion within the image sensing device 1 performs an operation corresponding to the details of the operation performed by the user.

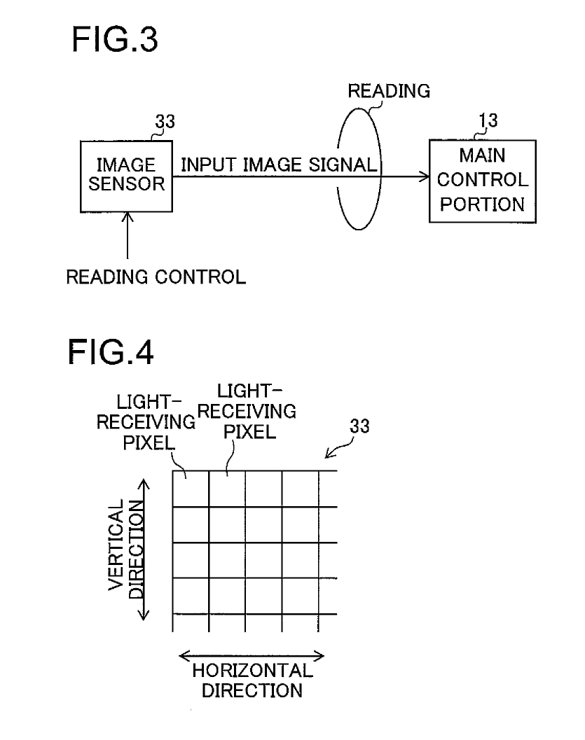

The image signal generated by the image sensor 33 is read from the image sensor 33 under reading control by the reading control portion 18, and is fed out to the main control portion 13 through the AFE 12. In the following description, unless particularly needed, the presence of the AFE 12 is ignored. Processing (hereinafter, referred also to as reading processing) for feeding, to the main control portion 13, the image signal generated by the image sensor 33 as an input image signal for the main control portion 13 corresponds to reading by the reading control portion 18 (see FIG. 3).

The image sensor 33 includes a plurality of light-receiving pixels that photoelectriclaly convert the subject image (the optical image of the subject) which enters them through the optical system 35 and the aperture 32; each light-receiving pixel performs the photoelectrical conversion to generate a light-receiving pixel signal having a signal value corresponding to the intensity of light entering the light-receiving pixel. As shown in FIG. 4, in the image sensor 33, a plurality of light-receiving pixels are arranged in a matrix along horizontal and vertical directions. The light-receiving pixel signal is one type of image signal.

As reading modes that specify the method of reading the light-receiving pixel signal, there are an all-pixel reading mode in which light-receiving pixel signals from all light-receiving pixels within the image sensor 33 are individually read, a thinning-out reading mode in which several light-receiving pixel signals are omitted by thinning-out and reading is performed and an addition reading mode in which reading is performed while a plurality of light-receiving pixel signals are being added. Here, the light-receiving pixel refers to a light-receiving pixel positioned within an effective pixel region of the image sensor 33. The word “reading mode” may be replaced by a word “drive mode.” The reading in the all-pixel reading mode, the reading in the thinning-out reading mode and the reading in the addition reading mode are also referred to as all-pixel reading, thinning-out reading and addition reading, respectively.

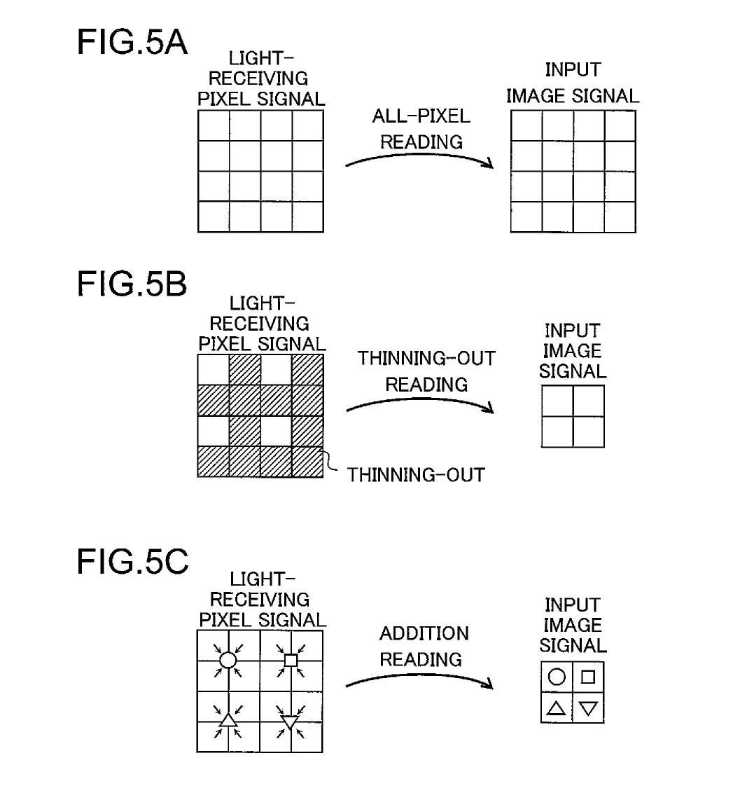

FIGS. 5A, 5B and 5C are respectively the conceptual diagrams of the all-pixel reading, the thinning-out reading and the addition reading.

In the all-pixel reading mode, the light-receiving pixel signals of all light-receiving pixels within the image sensor 33 are individually read as input image signals.

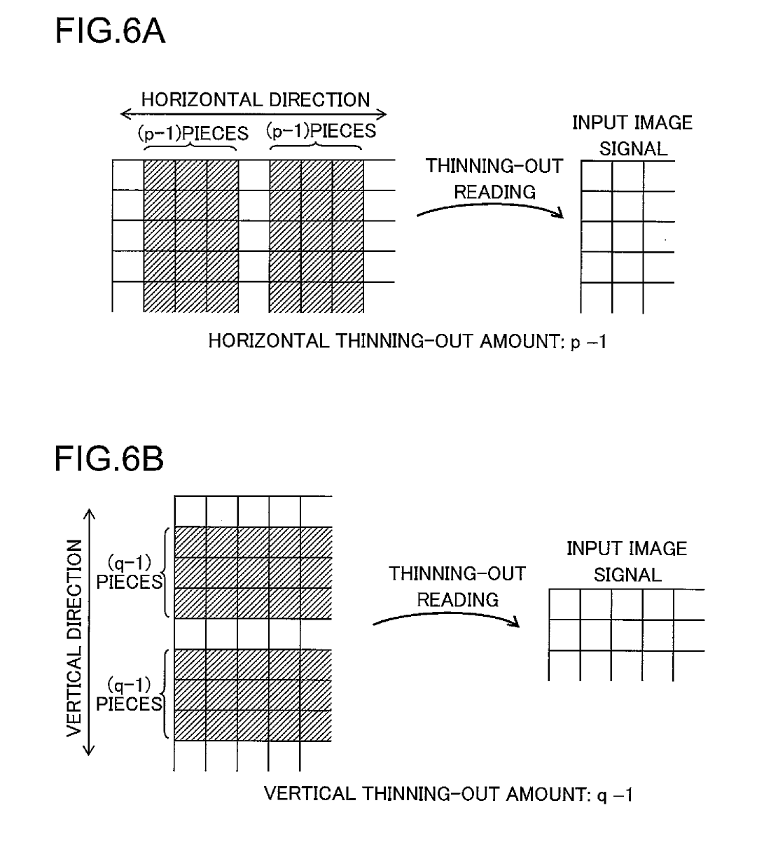

In the thinning-out reading, among all light-receiving pixels within the image sensor 33, only the light-receiving pixel signals of some light-receiving pixels are read as input image signals. In FIG. 5B, diagonally shaded portions represent light-receiving pixel signals (that is, light-receiving pixel signals that are not targets to be read) that are omitted by thinning-out. The same is true for FIGS. 6A and 6B, which will be described later. In the example of FIG. 5B, since, among (2×2) light-receiving pixel signals, three light-receiving pixel signals are omitted by thinning-out, the number of pixels in the image acquired by thinning-out reading is one half of the number of pixels in the image acquired by the all-pixel reading, in each of the horizontal and vertical directions.

In the addition reading, a plurality of small blocks are defined within the image sensor 33 so that, for each of the small blocks, a plurality of light-receiving pixel signals belonging to the small block are added to form one addition signal, and then an addition signal obtained in each of the small blocks is read as an input image signal. FIG. 5C shows how the (2×2) light-receiving pixel signals are added. The number of pixels in the image acquired by the addition reading of FIG. 5C is one half of the number of pixels in the image acquired by the all-pixel reading, in each of the horizontal and vertical directions.

In the thinning-out reading, a horizontal thinning-out amount and a vertical thinning-out amount are defined as follows.

In the thinning-out reading, when, as shown in FIG. 6A, among p light-receiving pixel signals aligned in the horizontal direction, (p−1) light-receiving pixel signals are omitted by thinning-out, and one light-receiving pixel signal is only read as an input image signal, the horizontal thinning-out amount is (p−1) whereas, when, as shown in FIG. 6B, among q light-receiving pixel signals aligned in the vertical direction, (q−1) light-receiving pixel signals are omitted by thinning-out, and one light-receiving pixel signal is only read as an input image signal, the vertical thinning-out amount is (q−1). Here, p and q are integers.

In the addition reading, a horizontal addition amount and a vertical addition amount are defined as follows.

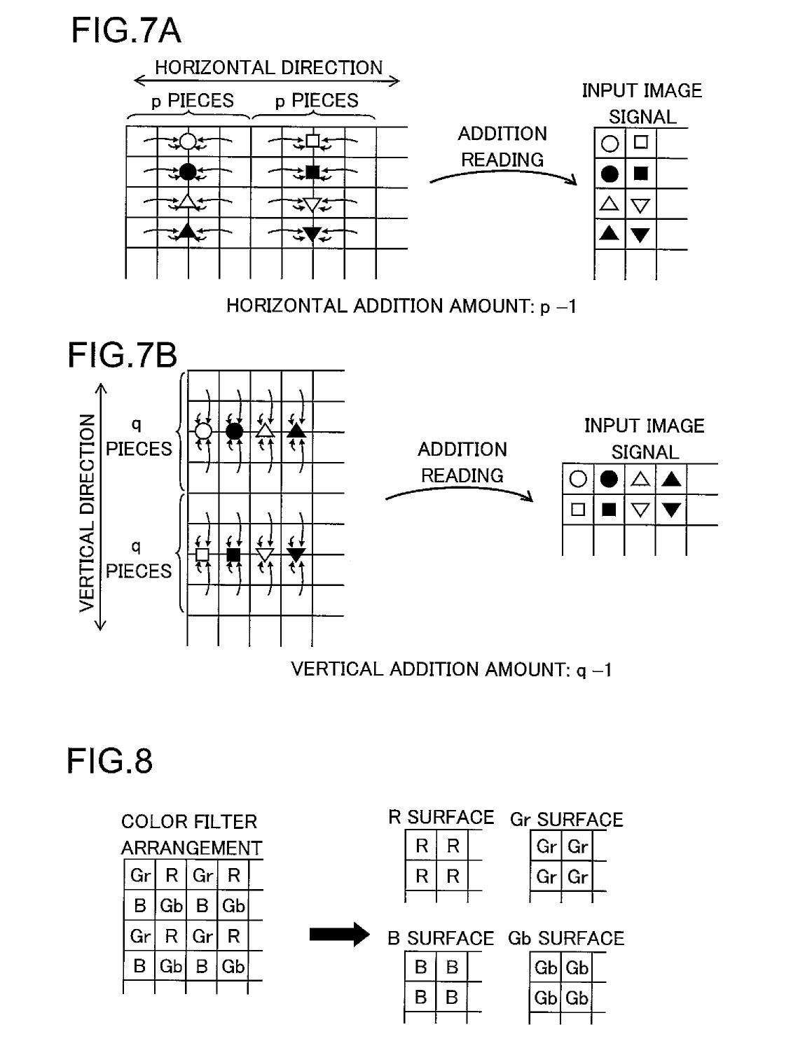

In the addition reading, when, as shown in FIG. 7A, p light-receiving pixel signals aligned in the horizontal direction are added to generate one input image signal, the horizontal addition amount is (p−1) whereas, when, as shown in FIG. 7B, q light-receiving pixel signals aligned in the vertical direction are added to generate one input image signal, the vertical addition amount is (q−1).

The thinning-out reading in which the horizontal thinning-out amount is zero and the addition reading in which the horizontal addition amount is zero correspond to the performance of the all-pixel reading in the horizontal direction. The thinning-out reading in which the vertical thinning-out amount is zero and the addition reading in which the vertical addition amount is zero correspond to the performance of the all-pixel reading in the vertical direction.

Although, for ease of description, the image sensor 33 has been assumed to be an image sensor capable of shooting only gray images, and the description has been given of the method of performing the thinning-out reading and the addition reading, the image sensor 33 is actually a signal-plate image sensor capable of shooting color images. Hence, on the front surface of the image sensor 33, as shown in FIG. 8, red green and blue color filters are arranged according to a predetermined rule (for example, the rule of Bayer arrangement). Thus, the image sensor 33 can be divided into an R surface that is formed with light-receiving pixel signals corresponding to red components, a B surface that is formed with light-receiving pixel signals corresponding to blue components and a G surface that is formed with light-receiving pixel signals corresponding to green components. Furthermore, among the light-receiving pixel signals corresponding to the green components, the G surface is divided into a Gr surface that is formed with light-receiving pixel signals aligned in the horizontal direction with respect to the light-receiving pixel signals corresponding to the red components and a Gb surface that is formed with light-receiving pixel signals aligned in the horizontal direction with respect to the light-receiving pixel signals corresponding to the blue components. Preferably, when thinning-out reading or addition reading is performed, the thinning-out reading or the addition reading described above is performed on each of the R, Gr, Gb and B surfaces, the results obtained by the reading are combined and thus an input image signal indicating a color image is formed. The image sensor 33 may be a three-plate image sensor where image sensors corresponding to the R, G and B surfaces are individually provided.

The reading mode selection portion 19 of FIG. 1 selects one reading mode from a plurality of predetermined reading modes (hereinafter referred also to as candidate reading modes). The selection method will be described later; a plurality of candidate reading modes can include the all-pixel reading mode, the thinning-out reading mode and the addition reading mode. The reading control portion 18 performs reading processing in the selected reading mode. The reading control portion 18 can periodically perform the reading processing at a frame rate determined by the main control portion 13. One sheet of still image (that is, one sheet of frame) that is formed by input image signals corresponding to one frame period is also referred to as an input image.

Based on the image signals of a plurality of input images obtained by sequentially moving the focus lens 31, the focus control portion 20 performs AF processing (focus processing) for detecting a focusing lens position. The focusing lens position is a position of the focus lens 31 (focus lens position) for forming the subject image on the image sensor 33. As the method of performing the focus processing, a known method can be utilized.

More specific operational examples and configuration examples of the image sensing device 1 based on the configuration discussed above will be described in a plurality of examples below. Unless a contradiction arises, what is described in a certain example can be applied to another example.

### First Example

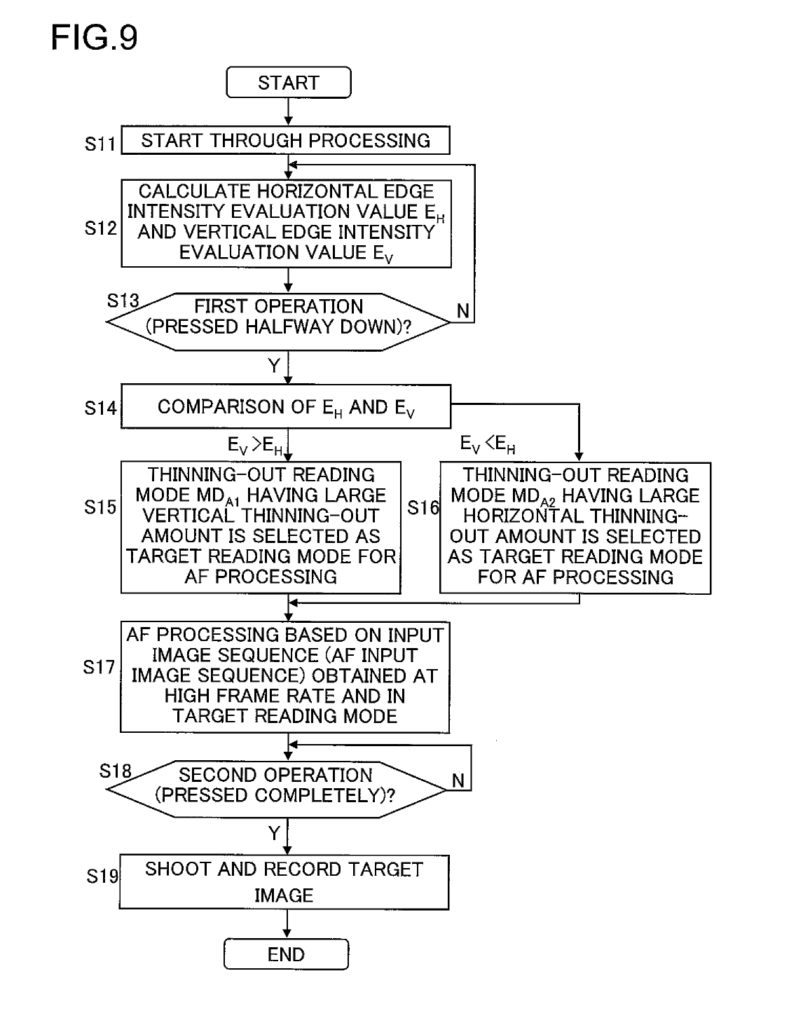

A first example will be described. FIG. 9 is an operational flow chart of the image sensing device 1 according to the first example. When the image sensing device 1 is started up, in step S11, the image sensing device 1 first starts through processing. In the through processing, an input image sequence is acquired by performing shooting at a predetermined frame rate, and the input image sequence is displayed as a moving image on the display screen 15. The input image sequence refers to a collection of a plurality of input images aligned chronologically. In the through processing, the input image sequence can be acquired using the all-pixel reading. The input image sequence in the through processing may be acquired using either thinning-out reading of relatively small horizontal and vertical thinning-out amounts or addition reading of relatively small horizontal and vertical addition amounts.

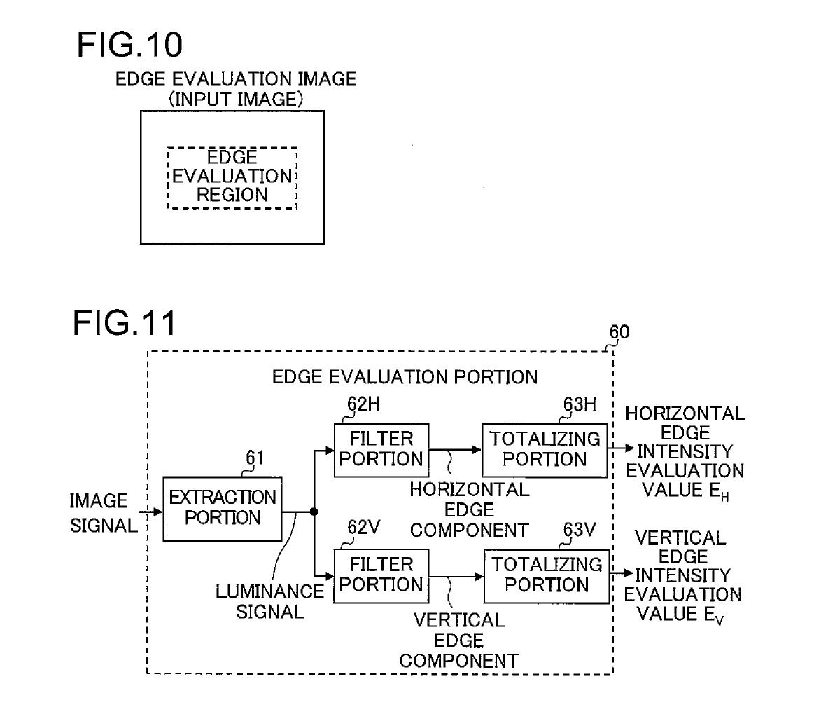

In step S12 subsequent to step S11, the image sensing device 1 regards each input image obtained by the through processing as an edge evaluation image (see FIG. 10), and can calculate edge information for each edge evaluation image. FIG. 11 shows an example of an internal block diagram of an edge evaluation portion 60 that calculates the edge information. The edge evaluation portion 60 can be provided within the main control portion 13 (in particular, for example, the reading mode selection portion 19). The edge evaluation portion 60 includes portions represented by symbols 61, 62H, 62V, 63H and 63V.

The edge evaluation portion 60 sets an edge evaluation region within the edge evaluation image (see FIG. 10). The edge evaluation region may be a part or all of the entire image region of the edge evaluation image and may be a combination region of a plurality of image regions that are separated from each other. In the example of FIG. 10, a region around the center of the edge evaluation image is assumed to be the edge evaluation region.

The extraction portion 61 extracts a luminance signal from the image signals of the edge evaluation image, and inputs the obtained luminance signal to the filter portions 62H and 62V. The filter portion 62H calculates a horizontal edge component of the input luminance signal; the filter portion 62V calculates a vertical edge component of the input luminance signal. The horizontal and vertical edge components calculated here are assumed to be their absolute values and to constantly have zero or positive values. The filter portions 62H and 62V calculate the horizontal and vertical edge components for each pixel within the edge evaluation region. The totalizing portion 63H totalizes the horizontal edge components determined for the individual pixels within the edge evaluation region, and determines the result of the totalizing as a horizontal edge intensity evaluation value E_{H}. The totalizing portion 63V totalizes the vertical edge components determined for the individual pixels within the edge evaluation region, and determines the result of the totalizing as a vertical edge intensity evaluation value E_{V}.

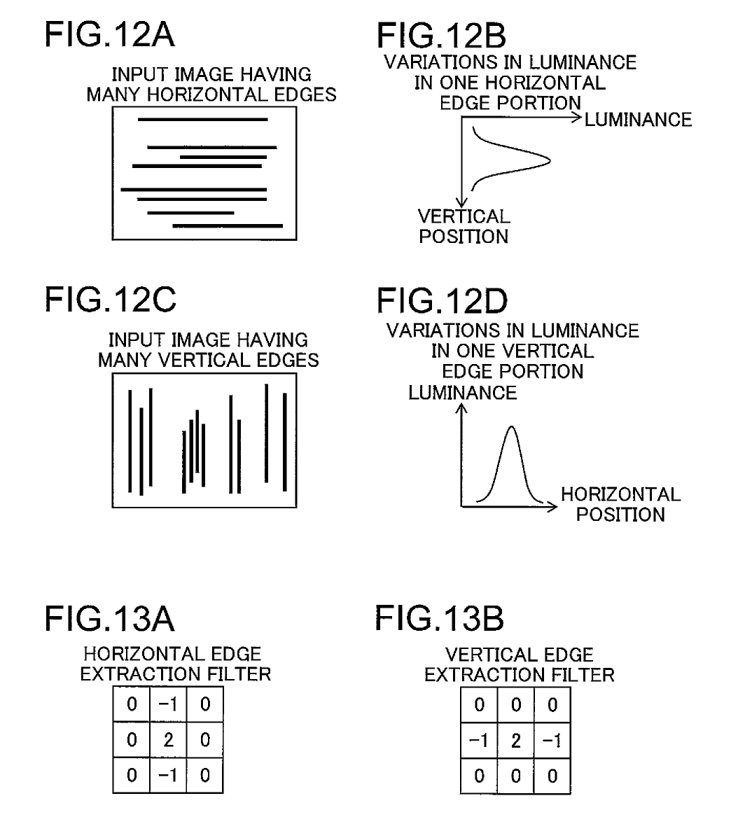

As is known, the edge refers to an image portion where variations in shade (variations in luminance signal) are rapidly produced. In the present specification, the horizontal edge is, as shown in FIGS. 12A and 12B, an edge extending along the horizontal direction; in the horizontal edge, variations in shade (variations in luminance signal) with respect to variations in position in the vertical direction are rapidly produced. The vertical edge is, as shown in FIGS. 12C and 12D, an edge extending along the vertical direction; in the vertical edge, variations in shade (variations in luminance signal) with respect to variations in position in the horizontal direction are rapidly produced.

The horizontal edge component has a value corresponding to a spatial frequency component (spatial frequency component in the vertical direction) SFC_{A} with respect to variations in position in the vertical direction, and are increased as the variations in shade with respect to variations in position in the vertical direction are increased. For example, a horizontal edge extraction filter as shown in FIG. 13A is used, and thus it is possible to determine the horizontal edge component of each pixel. When the horizontal edge extraction filter of FIG. 13A is used, a horizontal edge component EH_{CMP} of a noted pixel can be determined according to a formula “EH_{CMP}=|−Y₁+2·Y_{O}−Y₂|.” Here, Y_{O} is the luminance signal value of the noted pixel, and Y₁ and Y₂ are the luminance signal values of two pixels adjacent in the vertical direction with respect to the noted pixel.

The vertical edge component has a value corresponding to a spatial frequency component (spatial frequency component in the horizontal direction) SFC_{B} with respect to variations in position in the horizontal direction, and are increased as the variations in shade with respect to variations in position in the horizontal direction are increased. For example, a vertical edge extraction filter as shown in FIG. 13B is used, and thus it is possible to determine the vertical edge component of each pixel. When the vertical edge extraction filter of FIG. 13B is used, a vertical edge component EV_{cmp} of the noted pixel can be determined according to a formula “EV_{CMP}=|−Y₃+2·Y_{O}−Y₄|.” Here, Y₃ and Y₄ are the luminance signal values of two pixels adjacent in the horizontal direction with respect to the noted pixel.

As is clear from the above description, the edge evaluation portion 60 evaluates the spatial frequency component of the image signal of the edge evaluation image in each of the horizontal and vertical directions, and determines the evaluation result as horizontal and vertical edge intensity evaluation values E_{H} and E_{V}. The evaluation value E_{V} is an evaluation value (first edge intensity) corresponding to the spatial frequency component SFC_{B} in the horizontal direction; the evaluation value E_{H} is an evaluation value (second edge intensity) corresponding to the spatial frequency component SFC_{A} in the vertical direction.

Reference is made again to FIG. 9. In step S13 subsequent to step S12, the main control portion 13 determines whether or not a predetermined first operation is performed on the operation portion 17. If the first operation is performed, the process is changed from step S13 to step S14 whereas, if the first operation is not performed, the process is returned to step S12. The first operation is, for example, an operation of pressing a shutter button (unillustrated) provided in the operation portion 17 halfway down.

In step S14, the reading mode selection portion 19 compares the evaluation values E_{V} and E_{H} that are obtained immediately before the first operation is performed. The processing in step S12 may also be performed immediately after the first operation is performed, and the evaluation values E_{V} and E_{H} immediately after the first operation is performed may be compared in step S14. Based on the comparison result of step S14, the reading mode selection portion 19 performs selection processing in step S15 when an inequality “E_{V}>E_{H}” holds true whereas the reading mode selection portion 19 performs selection processing in step S16 when an inequality “E_{V}<E_{H}” holds true. In each of the selection processing in step 15 and the selection processing in step 16, a reading mode (hereinafter referred to as a target reading mode) used in AF processing is selected from a plurality of candidate reading modes.

The candidate reading modes include a thinning-out reading mode MD_{A1} in which the vertical thinning-out amount is more than the horizontal thinning-out amount and a thinning-out reading mode MD_{A2} in which the horizontal thinning-out amount is more than the vertical thinning-out amount. The selection portion 19 selects, in step S15, the thinning-out reading mode MD_{A1} as the target reading mode, and selects, in step S16, the thinning-out reading mode MD_{A2} as the target reading mode. The horizontal thinning-out amount in the mode MD_{A1} and the vertical thinning-out amount in the mode MD_{A2} may be zero. Hence, for example, in the mode MD_{A1}, the vertical thinning-out amount may be one or more and the horizontal thinning-out amount may be zero; in the mode MD_{A2}, the horizontal thinning-out amount may be one or more and the vertical thinning-out amount may be zero.

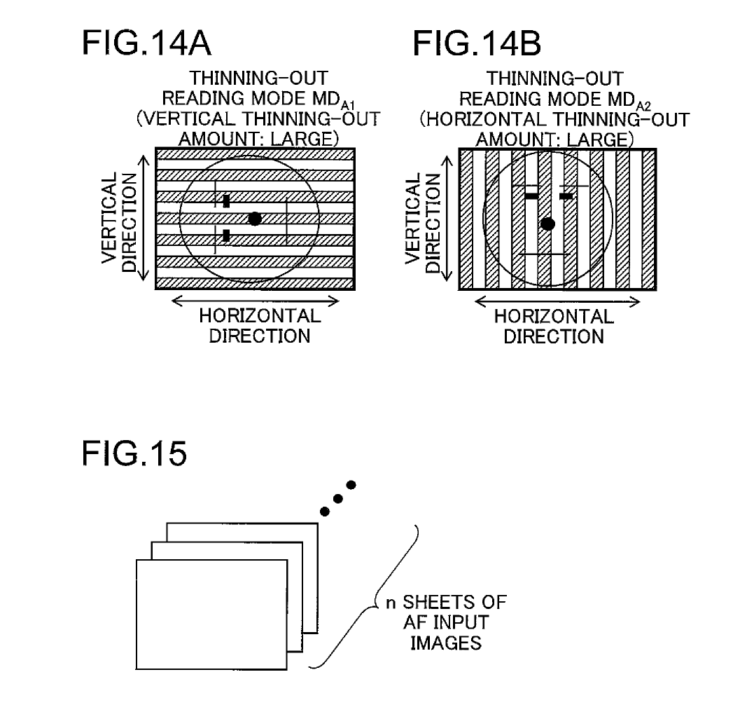

FIG. 14A shows the state of an input image when the mode MD_{A1} having a large vertical thinning-out amount is selected as the target reading mode as a result of an intense vertical edge (edge along the vertical direction) of the subject image. FIG. 14B shows the state of the input image when the mode MD_{A2} having a large horizontal thinning-out amount is selected as the target reading mode as a result of an intense horizontal edge (edge along the horizontal direction) of the subject image. In FIGS. 14A and 14B, portions omitted by the thinning-out are represented by diagonally shaded portions.

After the selection of the target reading mode in step S15 or S16, the reading control portion 18 performs reading processing in the target reading mode at a relatively high frame rate (at least a frame rate higher than a frame rate in the all-pixel reading mode) corresponding to the target reading mode. With reference to the frame rate at which the target reading mode is the all-pixel reading mode, when the target reading mode is the thinning-out reading mode (for example, the mode MD_{A1} or MD_{A2}), it is possible to increase the frame rate. As a result of the reading processing in the target reading mode, n sheets of input images (hereinafter also referred to as AF input images) used in the AF processing can be obtained (see FIG. 15). Here, n is an integer of two or more. The n sheets of AF input images are shot while the focus lens 31 is being moved by a predetermined amount within the range of the movement of the focus lens 31. In other words, the n sheets of AF input images are acquired with the focus lens 31 arranged in a different position.

In step S17, based on the spatial frequency component of the image signal of the n sheets of AF input images, the focus control portion 20 performs the AF processing (focus processing) for detecting the focusing lens position. The focusing lens position is the position of the focus lens 31 for maximizing the contrast (in other words, the edge intensity including the horizontal and vertical edge components) of the input image. Since the method of detecting the focusing lens position with the contrast detection method is known, its detailed description is omitted.

After the focusing lens position is determined, the position of the focus lens 31 is fixed to the focusing lens position. Thereafter, if a predetermined second operation (for example, an operation of fully pressing the shutter button) is performed on the operation portion 17 (step S18), an input image corresponding to the second operation is acquired as the target image in the all-pixel reading mode (step S19). The target image is recorded in the recording medium 16.

As shown in FIG. 14A, even when, for a subject image having an intense edge component along the vertical direction, the vertical thinning-out amount is increased correspondingly, little effect is produced on the AF accuracy (the detection accuracy of the focusing lens position). This is because, along horizontal lines (horizontal lines within white portions of FIG. 14A) that are not the target for thinning-out, edge information necessary for the AF processing is sufficiently extracted. On the other hand, as shown in FIG. 14B, even when, for a subject image having an intense edge component along the horizontal direction, the horizontal thinning-out amount is increased correspondingly, little effect is produced on the accuracy of the AF processing (the detection accuracy of the focusing lens position). This is because, along vertical lines (vertical lines within white portions of FIG. 14B) that are not the target for thinning-out, the edge information necessary for the AF processing is sufficiently extracted. In consideration of what has been described above, in the operation of FIG. 9, based on the horizontal and vertical edge intensity evaluation values E_{H} and E_{V}, the thinning-out reading mode corresponding to the edge state of the subject image is selected, and the AF processing is performed. Thus, it is possible to reduce the degradation of the AF accuracy and increase the frame rate at the time of the AF processing. Consequently, it is possible to acquire necessary AF accuracy and achieve high-speed AF.

### Second Example

A second example will be described. Although, in the example of FIG. 9, based on the comparison result of the evaluation values E_{H} and E_{V}, the thinning-out reading mode MD_{A1} or MD_{A2} is selected as the target reading mode, based on the comparison result of the evaluation values E_{H} and E_{V}, the target reading mode may be selected from three or more reading modes. In the following description, unless otherwise particularly described, the E_{H} and E_{V} are assumed to refer to the evaluation values E_{H} and E_{V} that are compared in step S14 (the same is true for a third example and the like).

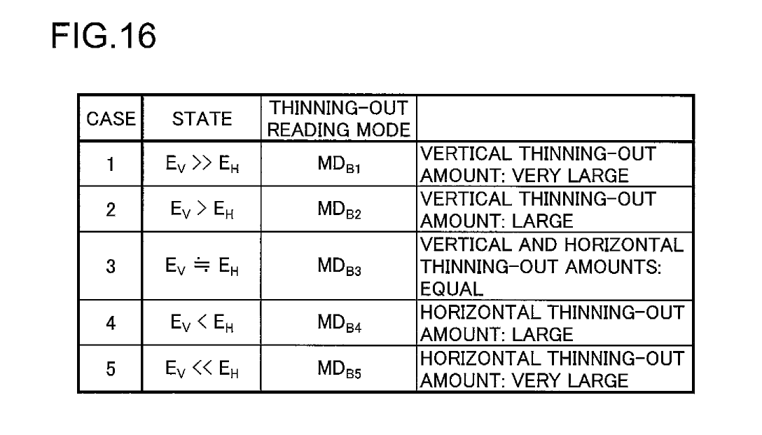

Consider, as an example, a case where the candidate reading modes include five different thinning-out reading modes MD_{B1}, MD_{B2}, MD_{B3}, MD_{B4} and MD_{B5} (see FIG. 16). In this case, after steps S11 to S13 of FIG. 9, the reading mode selection portion 19 compares the evaluation values E_{H} and Eᵥ in step S14, and selects, based on the result of the comparison, any of the thinning-out reading modes MD_{B1}, MD_{B2}, MD_{B3}, MD_{B4} and MD_{B5} as the target reading mode. After the selection of the target reading mode, the operation of the image sensing device 1 is the same as described in the first example.

Specifically, for example, as shown in FIG. 16, the selection portion 19 selects: in the first case where the inequalities “E_{V}>E_{H}” and “TH₂≦|E_{V}−E_{H}|” hold true, the thinning-out reading mode MD_{B1} as the target reading mode; in the second case where the inequalities “E_{V}>E_{H}” and “TH₁≦|E_{V}−E_{H}|<TH₂” hold true, the thinning-out reading mode MD_{B2} as the target reading mode; in the third case where the inequality “|E_{V}−E_{H}|<TH₁” holds true, the thinning-out reading mode MD_{B3} as the target reading mode; in the fourth case where the inequalities “E_{V}<E_{H}” and “TH₁≦|E_{V}−E_{H}|<TH₂” hold true, the thinning-out reading mode MD_{B4} as the target reading mode; and, in the fifth case where the inequalities “E_{V}<E_{H}” and “TH₂≦|E_{V}−E_{H}|” hold true, the thinning-out reading mode MD_{B5} as the target reading mode. Here, TH₁ and TH₂ are predetermined threshold values that satisfy an inequality “0<TH₁<TH₂.”

In the modes MD_{B1} and MD_{B2}, as in the mode MD_{A1} of FIG. 14A, the vertical thinning-out amount is more than the horizontal thinning-out amount. For example, the mode MD_{B2} may be the same as the mode MD_{A1} of FIG. 14A. Since, in the comparison of the first and second cases, the presence of a more intense vertical edge is expected in the first case, the vertical thinning-out amount in the mode MD_{B1} can be set more than the vertical thinning-out amount in the mode MD_{B2}. In this way, in the first case, without the loss of the AF accuracy, it is possible to further increase the speed of the AF processing than in the second case (to further increase the frame rate in the AF processing). When the mode MD_{B1} is actually selected as the target reading mode, the frame rate at which the AF input image is shot is preferably increased as compared with the case where the mode MD_{B2} is selected as the target reading mode.

In the modes MD_{B4} and MD_{B5}, as in the mode MD_{A2} of FIG. 14B, the horizontal thinning-out amount is more than the vertical thinning-out amount. For example, the mode MD_{B4} may be the same as the mode MD_{A2} of FIG. 14B. Since, in the comparison of the fourth and fifth cases, the presence of a more intense horizontal edge is expected in the fifth case, the horizontal thinning-out amount in the mode MD_{B5} can be set more than the horizontal thinning-out amount in the mode MD_{B4}. In this way, in the fifth case, without the loss of the AF accuracy, it is possible to further increase the speed of the AF processing than in the fourth case (to further increase the frame rate in the AF processing). When the mode MD_{B5} is actually selected as the target reading mode, the frame rate at which the AF input image is shot is preferably increased as compared with the case where the mode MD_{B4} is selected as the target reading mode.

In the third case, it can be considered that substantially equal amounts of horizontal and vertical edges are present within the input image. Hence, in the mode MD_{B3} corresponding to the third case, the vertical thinning-out amount is preferably set equal to (completely equal to or substantially equal to) the horizontal thinning-out amount. In the third case, a priority may be given to the AF accuracy, and thus the all-pixel reading mode may be selected as the target reading mode.

### Third Example

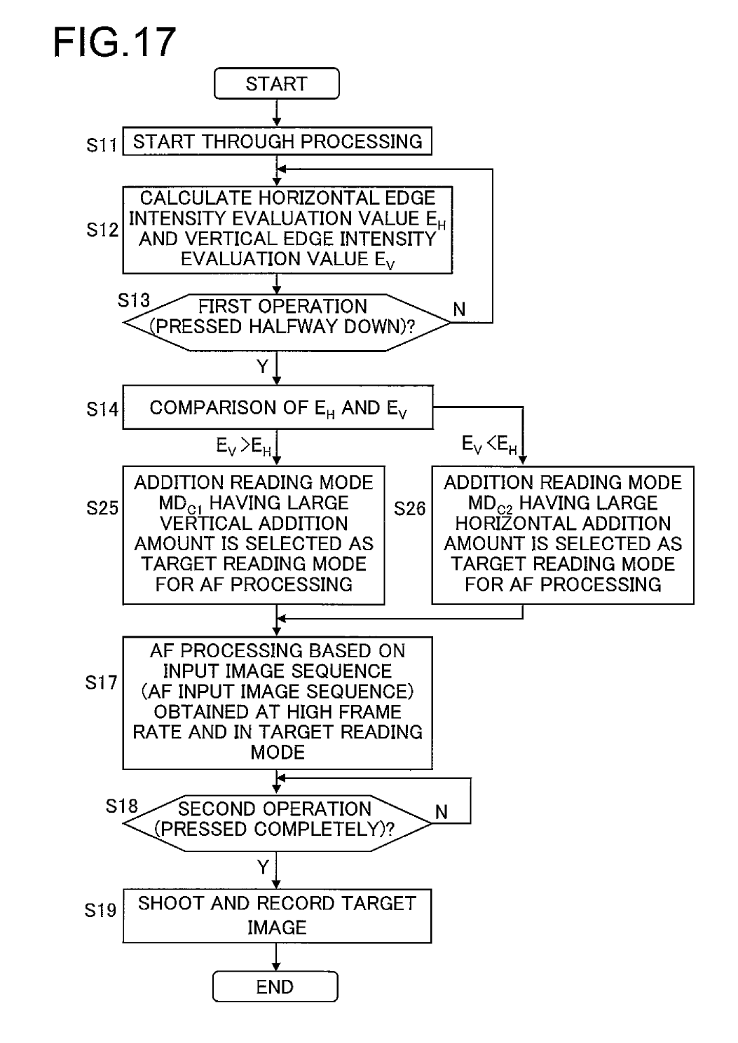

A third example will be described. In the first example, the thinning-out reading may be replaced by the addition reading. Specifically, instead of FIG. 9, the operation of FIG. 17 may be performed. FIG. 17 is an operational flow chart of an image sensing device 1 according to the third example. In the third example, as in the first example, after the processing in steps S11 to S13, the evaluation values E_{H} and E_{V} are compared in step S14. As a result of the comparison, the selection portion 19 performs selection processing in step S25 when the inequality “E_{V}>E_{H}” holds true whereas the selection portion 19 performs selection processing in step S26 when the inequality “E_{V}<E_{H}” holds true. In the selection processing in steps 25 and 26, the target reading mode is selected from a plurality of candidate reading modes.

The candidate reading modes include an addition reading mode MD_{C1} in which the vertical addition amount is more than the horizontal addition amount and an addition reading mode MD₂ in which the horizontal addition amount is more than the vertical addition amount. The selection portion 19 selects, in step S25, the addition reading mode MD_{C1} as the target reading mode, and selects, in step S26, the addition reading mode MD_{C2} as the target reading mode. The horizontal addition amount in the mode MD_{C1} and the vertical addition amount in the mode MD_{C2} may be zero. Hence, for example, in the mode MD_{C1}, the vertical addition amount may be one or more and the horizontal addition amount may be zero; in the mode MD_{C2}, the horizontal addition amount may be one or more and the vertical addition amount may be zero. The operation of the image sensing device 1 after the selection of the target reading mode is the same as described in the first example. With reference to the frame rate at which the target reading mode is the all-pixel reading mode, when the target reading mode is the addition reading mode (for example, the mode MD_{C1} or MD_{C2}), it is possible to increase the frame rate.

FIG. 14A also shows an example of the input image when the mode MD_{C1} having a large vertical addition amount is selected as the target reading mode as a result of the intense vertical edge (edge along the vertical direction) of the subject image. FIG. 14B also shows the state of the input image when the mode MD_{C2} having a large horizontal addition amount is selected as the target reading mode as a result of the intense horizontal edge (edge along the horizontal direction) of the subject image.

Although signal addition in the vertical direction corresponds to low-pass filter processing in the vertical direction, and thus the horizontal edge (see FIG. 12A) is blunted, the vertical edge (see FIG. 12C) is left even if it is subjected to the signal addition in the vertical direction. On the other hand, although signal addition in the horizontal direction corresponds to low-pass filter processing in the horizontal direction, and thus the vertical edge is blunted, the horizontal edge is left even if it is subjected to the signal addition in the horizontal direction. In consideration of what has been described above, in the operation of FIG. 17, based on the horizontal and vertical edge intensity evaluation values E_{H} and E_{V}, the addition reading mode corresponding to the edge state of the subject image is selected, and the AF processing is performed. Thus, it is possible to reduce, as in the first example, the degradation of the AF accuracy and increase the frame rate at the time of the AF processing. Consequently, it is possible to acquire necessary AF accuracy and achieve high-speed AF.

### Fourth Example

A fourth example will be described. As the first example is varied to the second example, the third example can also be varied as follows.

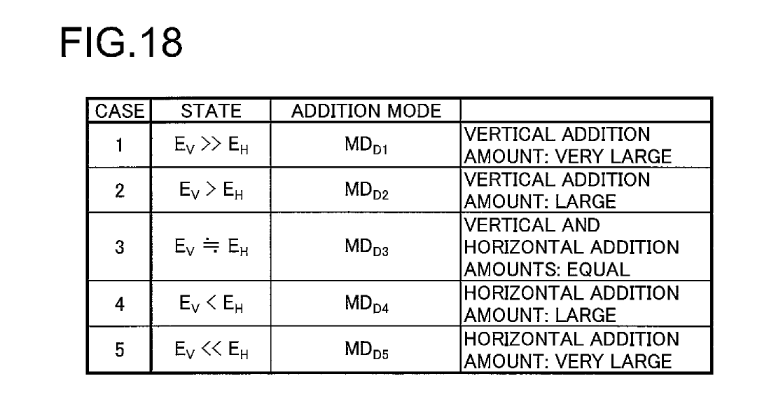

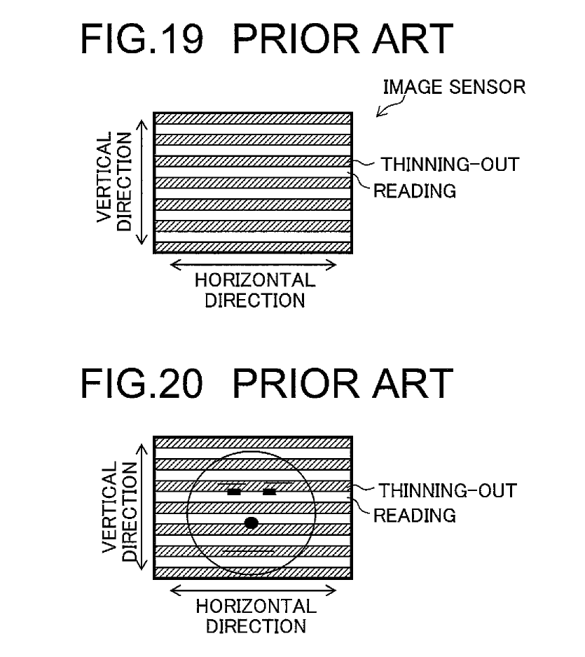

Consider, as an example, a case where the candidate reading modes include five different addition reading modes MD_{D1}, MD_{D2}, MD_{D3}, MD_{D4} and MD_{D5} (see FIG. 18). In this case, after steps S11 to S13 of FIG. 17, the reading mode selection portion 19 compares the evaluation values E_{H} and E_{V} in step S14, and selects, based on the result of the comparison, any of the addition reading modes MD_{D1}, MD_{D2}, MD_{D3}, MD_{D4} and MD_{D5} as the target reading mode. After the selection of the target reading mode, the operation of the image sensing device 1 is the same as described in the first example.

Specifically, for example, as shown in FIG. 18, in the first, the second, the third, the fourth and the fifth cases, the selection portion 19 selects, as the target reading modes, the addition reading modes MD_{D1}, MD_{D2}, MD_{D3}, MD_{D4} and MD_{D5}, respectively. The significance of the first to fifth cases is the same as described in the second example.

In the modes MD_{D1} and MD_{D2}, similarly to the mode MD_{A1} of FIG. 14A, the vertical addition amount is more than the horizontal addition amount. Since, in the comparison of the first and second cases, the presence of a more intense vertical edge is expected in the first case, the vertical addition amount in the mode MD_{D1} can be set more than the vertical addition amount in the mode MD_{D2}. In this way, in the first case, without the loss of the AF accuracy, it is possible to further increase the speed of the AF processing than in the second case (to further increase the frame rate in the AF processing). When the mode MD_{D1} is actually selected as the target reading mode, the frame rate at which the AF input image is shot is preferably increased as compared with the case where the mode MD_{D2} is selected as the target reading mode.

In the modes MD_{D4} and MD_{D5}, similarly to the mode MD_{A2} of FIG. 14B, the horizontal addition amount is more than the vertical addition amount. Since, in the comparison of the fourth and fifth cases, the presence of a more intense horizontal edge is expected in the fifth case, the horizontal addition amount in the mode MD_{D5} can be set more than the horizontal addition amount in the mode MD_{D4}. In this way, in the fifth case, without the loss of the AF accuracy, it is possible to further increase the speed of the AF processing than in the fourth case (to further increase the frame rate in the AF processing). When the mode MD_{D5} is actually selected as the target reading mode, the frame rate at which the AF input image is shot is preferably increased as compared with the case where the mode MD_{D4} is selected as the target reading mode.

In the third case, it can be considered that substantially equal amounts of horizontal and vertical edges are present within the input image. Hence, in the mode MD_{D3} corresponding to the third case, the vertical addition amount is preferably set equal to (completely equal to or substantially equal to) the horizontal addition amount. In the third case, a priority may be given to the AF accuracy, and thus the all-pixel reading mode may be selected as the target reading mode.

<<Variations and the Like>>

In the embodiment of the present invention, many modifications are possible as appropriate within the scope of the technical spirit shown in the scope of claims. The embodiment described above is simply examples of the embodiment of the present invention; the present invention or the significance of terms of constituent requirements is not limited to what has been described in the embodiment discussed above. The specific values indicated in the above description are simply illustrative; naturally, they can be changed to various values. Explanatory notes 1 to 3 will be described below as explanatory matters that can be applied to the embodiment described above. The subject matters of the explanatory notes can freely be combined together unless a contradiction arises.

### Explanatory Note 1

The image sensing device 1 may be incorporated in an arbitrary device (a mobile terminal such as a mobile telephone).

### Explanatory Note 2

In the AF processing (focus processing) described above, the image sensor 33 is fixed, then the focus lens 31 is sequentially moved and, based on the image signals of a plurality of input images obtained in the movement process, the focusing lens position is detected. As is known, the AF processing as described above can be realized by moving the image sensor 33 instead of the focus lens 31. In other words, alternatively, in the AF processing (focus processing), the focus lens 31 is fixed, then the image sensor 33 is sequentially moved and, based on the image signals of a plurality of input images obtained in the movement process, a focusing sensor position is detected. In this case, the second operation is performed (see FIG. 9 and the like), and thus the target image is acquired in the all-pixel reading mode with the image sensor 33 arranged in the focusing sensor position. Except that the movement targets are different, the method of detecting the focusing sensor position is the same as the method of detecting the focusing lens position described above.

The focusing lens position is a position of the focus lens 31 for forming (focusing) the subject image on the image sensor 33, and is a position with reference to the position of the image sensor 33. On the other hand, the focusing sensor position is a position of the image sensor 33 for forming (focusing) the subject image on the image sensor 33, and is a position with reference to the position of the focus lens 31. Since the focusing lens position and the focusing sensor position indicate a relative position relationship between the focus lens 31 and the image sensor 33 for forming (focusing) the subject image on the image sensor 33, the AF processing (focus processing) can be said to be processing for detecting the relative position relationship. When the relative position relationship is determined, both the focus lens 31 and the image sensor 33 may be moved. Processing for moving, after the detection of the relative position relationship, the focus lens 31 or the image sensor 33 to the focusing lens position or the focusing sensor position determined by the relative position relationship may be considered to be included in the AF processing.

### Explanatory Note 3

The image sensing device 1 of FIG. 1 can be formed with hardware or a combination of hardware and software. When the image sensing device 1 is formed with software, the block diagram of a portion realized by the software represents a functional block diagram of the portion. The function realized by the software may be described as a program, and, by executing the program on a program execution device (for example, a computer), the function may be realized.

Specifically, for example, a CPU (central processing unit) is provided in the main control portion 13, a program stored in an unillustrated flash memory is executed by the CPU and thus the functions described above can be realized. In the configuration of FIG. 1, for example, the CPU, the image sensing portion 11, the AFE 12, the internal memory 14, the display screen 15, the recording medium 16 and the operation portion 17 can be formed with hardware, and the reading control portion 18, the reading mode selection portion 19 and the focus control portion 20 can be formed with software. All or part of the reading control portion 18, the reading mode selection portion 19 and the focus control portion 20 may be formed with hardware.

What is claimed is:

1. An image sensing device comprising:
an image sensor that generates an image signal of a subject image which enters the image sensor through a focus lens;
a reading control portion that reads the image signal in a reading mode which is selected from a plurality of reading modes for reading the image signal from the image sensor;
a focus control portion that performs focus processing which detects, based on the image signal read by the reading control portion, a relative position relationship between the focus lens and the image sensor for focusing the subject image; and
a reading mode selection portion that selects, based on the image signal read from the image sensor, a reading mode for performing the focus processing.

2. The image sensing device of claim 1,
wherein the reading mode selection portion selects the reading mode based on a spatial frequency component of the image signal read from the image sensor.

3. The image sensing device of claim 2,
wherein the reading mode selection portion evaluates the spatial frequency component of the image signal read from the image sensor in each of horizontal and vertical directions, and selects the reading mode based on a result of the evaluation.

4. The image sensing device of claim 3,
wherein the reading modes include first and second thinning-out reading modes for performing thinning-out reading on the image signal,
in the first thinning-out reading mode, a thinning-out amount in the vertical direction is more than a thinning-out amount in the horizontal direction,
in the second thinning-out reading mode, the thinning-out amount in the horizontal direction is more than the thinning-out amount in the vertical direction, and
the reading mode selection portion selects, based on the result of the evaluation, the first thinning-out reading mode or the second thinning-out reading mode.

5. The image sensing device of claim 4,
wherein the reading mode selection portion determines, from the image signal read from the image sensor, a first edge intensity corresponding to the spatial frequency component in the horizontal direction and a second edge intensity corresponding to the spatial frequency component in the vertical direction, and
the reading mode selection portion selects the first thinning-out reading mode when the first edge intensity is more than the second edge intensity whereas the reading mode selection portion selects the second thinning-out reading mode when the second edge intensity is more than the first edge intensity.

6. The image sensing device of claim 3,
wherein the reading modes include first and second addition reading modes in which a result of addition of signals of a plurality of light-receiving pixels provided in the image sensor is included in the image signal and the image signal is read,
in the first addition reading mode, a number of signals added is more in the vertical direction than in the horizontal direction,
in the second addition reading mode, the number is more in the horizontal direction than in the vertical direction and
the reading mode selection portion selects the first or the second addition reading mode based on the result of the evaluation.

7. The image sensing device of claim 6,
wherein the reading mode selection portion determines, from the image signal read from the image sensor, a first edge intensity corresponding to the spatial frequency component in the horizontal direction and a second edge intensity corresponding to the spatial frequency component in the vertical direction, and
the reading mode selection portion selects the first addition reading mode when the first edge intensity is more than the second edge intensity whereas the reading mode selection portion selects the second addition reading mode when the second edge intensity is more than the first edge intensity.
